(19) United States
(12) Patent Application Publication
(10) Pub. No.: US 2005/0272876 A1
(43) Pub. Date: Dec. 8, 2005

(54) Process for emulsion graft polymerization and products thereof

(75) Inventors: Noriaki Seko, Takasaki-shi (JP); Masao Tamada, Takasaki-shi (JP)

Correspondence Address: BANNER & WITCOFF, 1001 G STREET N W, SUITE 1100, WASHINGTON, DC, 20001, US

(73) Assignee: Japan Atomic Energy Research Institute, Kashiwa-shi (JP)

(21) Appl. No.: 11/141,039

(22) Filed: Jun. 1, 2005

(30) Foreign Application Priority Data
Jun. 4, 2004 (JP) 2004-167017

(51) Int. Cl. C08F 2/00

(52) U.S. Cl. 525/242

(57) ABSTRACT

A process for emulsion graft polymerization of a polymeric substrate, which comprises a step of activating a polymeric substrate, and a step of contacting the activated polymeric substrate with an emulsion comprising a surfactant, water, and reactive monomers, thereby graft polymerizing the reactive monomers to the polymeric substrate, and products polymerized by the process, where the surfactant is selected from the group consisting of an anionic surfactant, a cationic surfactant, an amphoric surfactant, a non-ionic surfactant and a mixture thereof, and the polymeric substrate is in the form of woven fabrics, non-woven fabrics, films, hollow filamentary films, flat films or threads, made from polyolefinic fibers such as polyethylene, polypropylene, etc., or natural polymeric fibers such as chitin, chitosan, cellulose, starch, etc.

### BACKGROUND OF THE INVENTION

The present invention relates to a process for emulsion graft polymerization and products thereof, and more particularly to a process for graft polymerizing a polymeric substrate, without any cross-linking reaction pretreatment, in an emulsion of water-insoluble monomers dispersed in water in the presence of a surfactant, and products thereof.

Process for graft polymerization is a process for introducing reactive monomers into a given polymeric substrate as graft chains and is useful because especially working functions can be given to the polymeric substrate by graft polymerization of reactive monomers having specifically working functional groups.

Polymerization in a solvent-based dispersion comprising an aqueous component and a non-aqueous component has been studied as a process for graft polymerization. Polymerization in the solvent-based dispersion, that is, emulsion polymerization, is to graft polymerize a polymeric substrate through reaction with an emulsion comprising reactive monomers, an emulsifier and water. A process for reaction of radiation-crosslinked polymers as a substrate in an emulsion to form an electrochemical cell membrane has been proposed as a process for emulsion graft polymerization (e.g. JP-A-2002-524626). Another process for polymerization in a monomer solution emulsified by a surfactant by an oxidation-reduction reaction using a redox catalyst has been also studied (e.g. N. Yu. Mosina et al: “Some features of the heterophase emulsion graft polymerization of glycidyl methacrylate to polycaproamide fiber”, Chemistry and Technology of Man-made Fiber, Plenum Publishing Corporation, U.S.A, 1992, 5, p. 351-354).

However, emulsion graft polymerization has a problem that the dispersion turns heterogeneous, so the reaction fails to proceed fully. The problem is significant in the case of using reactive monomers with poor compatibility with water. An attempt to stabilize shapes of liquid droplets in the emulsion by continuously stirring the reaction system during the polymerization reaction has been disclosed (e.g. Val. N. Judrysvtsev et al.: “Polypropylene modification by the radiation graft polymerization of N-vinylcaprolactam”, High Energy Chemistry, Kluwer Academic Publishers, Netherlands, 2003, 37, p. 382-388), or emulsion graft polymerization of water-soluble polymers has been attempted (e.g. V. N. Kislenko: “Emulsion graft polymerization: mechanism of formation of dispersions”, Colloids and Surfaces A; Physicochemical and Engineering Aspects, Netherlands, Elsevier Science, 1999, 152, p. 199-203). However, there have not yet been any successful cases of efficient polymerization of reactive monomers with general-purpose solid polymeric substrate without any crosslinking reaction pretreatment.

Thus, there is a need for a process for emulsion graft polymerization in an aqueous emulsion directed to general-purpose polymeric substrates without any crosslinking reaction pretreatment, which can give desired specifically working functions to the polymeric substrates by efficient polymerization of reactive monomers having poor compatibility with water. There is also a need for a metal ion adsorbent prepared by the process for emulsion graft polymerization in the aqueous emulsion.

### SUMMARY OF THE INVENTION

An object of the present invention is to provide a process for emulsion graft polymerization in an aqueous emulsion and also to provide products polymerized by the present process.

The object of the present invention can be attained by a process for emulsion graft polymerization of a polymeric substrate, which comprises a step of subjecting a polymeric substrate to radiation irradiation, thereby activating the polymeric substrate, and a step of contacting the activated polymeric substrate with an emulsion comprising a surfactant, water, and reactive monomers, thereby graft polymerizing the reactive monomers to the polymeric substrate.

The present invention provides a process for emulsion graft polymerization directed to general-purpose solid polymeric substrates without any crosslinking reaction pretreatment, which can give desired specifically working functions to the polymeric substrates by efficient polymerization of reactive monomers having poor compatibility with water. According to the present invention, graft polymerization is carried out in an aqueous emulsion using water as a solvent, resulting in suppression of damages to the polymeric substrates. Thus, an adsorbent with a high strength can be produced. Furthermore, a burden to the environments can be reduced due to the elimination of an organic solvent.

### BEST MODE FOR CARRYING OUT THE INVENTION

The present invention provides a process for emulsion graft polymerization of a polymeric substrate, which comprises a step of subjecting a polymeric substrate to radiation irradiation, thereby activating the polymeric substrate, and a step of contacting the activated polymeric substrate with an emulsion comprising a surfactant, water, and reactive monomers, thereby graft polymerizing the reactive monomers to the polymeric substrate.

Emulsion

The term “emulsion” used herein generally refers to a system of droplets of liquid reactive monomers insoluble in water dispersed in water as a solvent. The size of droplets of liquid reactive monomers is not limited, and includes microemulsion sizes of a few nm—a few tens nm and nanoemulsion sizes of about 1 nm. Thus, so long as there are liquid reactive monomers insoluble in water and water as a solvent, a water/oil interfacial tension can be lowered by addition of a surfactant thereto, thereby bringing about a system of apparently homogeneous mixture. It is construed that the emulsion so defined includes such a system of apparently homogeneous mixture.

Polymeric Substrate

Materials for the polymeric substrate are not particularly limited, and include, for example, polyolefinic fibers such as polyethylene, polypropylene, etc., and natural polymeric fibers such as chitin, chitosan, cellulose, starch, etc., and their forms are any one of woven fabrics, non-woven fabrics, films, hollow filamentary films, flat film, and threads, and may take any form made therefrom. General purpose polymeric substrate without any crosslinking pretreatment can be used as a polymeric substrate, so long as it is made from the aforementioned material and is in the aforementioned form.

Surfactant

The surfactant can be used upon appropriate selection of the surfactants in the ordinary use in the relevant technical field, including an anionic surfactant, a cationic surfactant, an amphoteric surfactant, a non-ionic surfactant, etc. A combination of a plurality thereof can be also used. The anionic surfactant is not particularly limited, and alkylbenzene-based, alcohol-based, olefin-based, phosphoric acid-based and amide-based surfactants are available. For example, sodium dodecylsulfate is recommended. The cationic surfactant is not particularly limited, but octadodecylamine acetate and trimethylammonium chloride are recommended. The non-ionic surfactant is not particularly limited, and ethoxylated fatty alcohol, fatty acid esters, etc. are available. For example, Tween 80 is recommended. The amphoteric surfactant is not particularly limited, and, for example, Amphitol (trademark of Kao Corp. Japan) is recommended.

Concentration of the surfactant to be used is not particularly limited, and can be properly selected, depending on the kind and concentration of reactive monomers. Concentration of the surfactant is preferably 0.1 to 10% on the basis of total weight of the solvent.

Dispersion into water of reactive monomers which are insoluble in water, as a solvent, can be promoted by use of the surfactant. Appearance of emulsion changes to various degrees, depending on the sizes of liquid droplets in the dispersal phase, but generally is in a milky turbid state and shows transparency by decreasing sizes of liquid droplets from microemulsion size to nanoemulsion size.

Water

Water as a solvent is not particularly limited, and deionized water, pure water and ultrapure water are recommended. By using not an organic solvent, but water as a solvent, a problem of waste liquid treatment can be overcome, contributing to environmental protection.

Reactive Monomers

Vinyl-containing reactive monomers can be used as reactive monomers, and a mixture of a plurality of monomers can be also used, where a concentration ratio of monomers in the mixture is not particularly limited and can be selected as desired.

Vinyl-containing monomers are not particularly limited, and include, for example, acrylonitrile, glycidyl methacrylate, acrylic acid, methacrylic acid, allylamine, etc.

Preferable reactive monomers include mono(2-methacryloyloxyethyl)acid phosphate CH₂═C(CH₃)COO(CH₂)₂OPO(OH)₂, di(2-methacryloyloxyethyl)acid phosphate [CH₂═C(CH₃)COO(CH₂)₂O]₂PO(OH), mono(2-acryloyloxyethyl)acid phosphate CH₂═CHCOO(CH₂)₂OPO(OH)₂, di(2-acryloyloxyethyl)acid phosphate [CH₂═CHCOO(CH₂)₂O]₂PO(OH), or their mixed monomers.

Monomer having the following chemical formula:
CH₂═C(CH₃)COO(CH₂)₁OCO—R—CO—OPO(OH)R′
where R is (CH₂)ₘ or C₆H₄, which may have a substituent, R′ is a hydroxyl group or CH₂═C(CH₃)COO(CH₂)ₙOCO—R—CO—O— group, and l, m, and n are independently integers of 1 to 6, can be also used as a reactive monomers.

Step of Activating Polymeric Substrate

In the present process, at first the polymeric substrate is activated. The term “activate” used herein refers to formation of reaction active sites on the polymeric substrate for graft polymerization of reactive monomers to the polymeric substrate. By contacting the polymeric substrate activated in this step with an emulsion containing the reactive monomers in the next step of graft polymerization, the reactive monomers can be graft polymerized to the polymeric substrate. At the time of forming reaction active sites, the substrate may be damaged due to substrate molecule breaking, but graft polymerization in water as a solvent in an emulsion state in the next step can reduce the necessary irradiation dosage for the activation, resulting in suppression of damage to the polymeric substrate.

The polymeric substrate can be activated by the following procedure (a) or (b).

(a) Radiation Irradiation

Polymeric substrate as nitrogen flushed in advance is subjected to radiation irradiation in a nitrogen atmosphere at room temperature or under cooling with dry ice, etc. The radiation to be used is an electron beam or y-rays, and the irradiation dosage can be selected as desired under such conditions that the dosage is sufficient to form reaction active sites, and typically is 1 to 200 kGy.

(b) Plasma Irradiation

Polymeric substrate as nitrogen flushed in advance is subjected to plasma irradiation in a nitrogen atmosphere at room temperature. Irradiation of the substrate is carried out at a high frequency of 10 MHz or more in a nitrogen atmosphere for a few minutes to a few hours.

Step of Graft Polymerization

Subsequent to the step of activating the polymeric substrate, the activated polymeric substrate is contacted with an emulsion comprising a surfactant, water, and reactive monomers, thereby graft polymerizing the reactive monomers to the polymeric substrate. Through this step, graft chains formed from the reactive monomers can be introduced into the polymeric substrate.

Graft polymerization can be carried out in a nitrogen atmosphere, but to attain a higher degree of grafting it is preferable that the atmosphere has a lower oxygen concentration. The term “degree of grafting” used herein refers to a weight increment (%) of the reactive monomers grafted to the polymeric substrate. Reaction temperature depends on the reactivity of reactive monomers and typically is 40 to 60° C. Reaction time is 30 minutes to 5 hours, but can be selected dependent on the reaction temperature and desired degree of grafting. Monomer concentration is normally about 5 to 30%, and can be properly selected because the monomer concentration is a conversion-determining factor together with the reaction temperature and the reaction time.

By using reactive monomers having specifically working functional groups in this step, formation of graft chains and introduction of chelating groups can be made in one step.

According to one preferred embodiment of the present process for emulsion graft polymerization of a polymeric substrate, the reactive monomers having a poor compatibility with water can be homogeneously dispersed and subjected to efficient graft polymerization, where the necessary irradiation dosage for the activation can be reduced, resulting in suppression of damages to the polymeric substrate, and the lack of necessity for using an organic solvent such as methanol, dimethyl sulfoxide, etc. also reduces the burden to the environments.

Another preferred embodiment of the present invention is a process for producing a metal ion adsorbent, which comprises a step of activating a polymeric substrate, and a step of contacting the activated polymeric substrate with an emulsion comprising a surfactant, water, and reactive monomers having specifically working functional groups, thereby graft polymerizing the reactive monomers having the specifically working functional groups to the polymeric substrate.

In this embodiment, the step of activating a polymeric substrate and the step of graft polymerization can be carried out in the same manner as already described above.

Step of Introducing Specifically Working Functional Groups

Subsequent to the step of graft polymerization, specifically working functional groups can be introduced, if desired, into the graft chains of reactive monomers formed by the graft polymerization. By introducing specifically working functional groups into the graft chains formed from the reactive monomers in this step, any desired specifically working functions can given to the polymeric substrate.

Metal Ion Adsorbent

The metal ion adsorbent produced according to this embodiment can recover metal ion species from a metal ion-containing fluid by adsorption while passing the fluid through the metal ion adsorbent. The metal ion-containing fluid can be a gas or a liquid. The adsorbed metal ions can be reutilized by washing the metal ion-adsorbed adsorbent by an appropriate eluent. The eluent is not particularly limited, and includes inorganic acids, organic acids, and organic solvents. After the elution, the adsorbent can be reutilized by washing with pure water and alternately dipping into hydrochloric acid and an aqueous sodium chloride solution.

The metal ion adsorbent can be packed into an ion exchange column, and to pass the fluid through a plurality of packed columns arranged in series or in parallel can improve ion recovery efficiency. By inserting a spacer between adsorbent layers in the packed column, the fluid resistance can be reduced, thereby improving the flowing state of the fluid passing through the packed column.

The present process for emulsion graft polymerization and products produced by the process have been described above, but the present invention should not be construed as being limited thereto.

### BRIEF DESCRIPTION OF THE DRAWINGS

FIG. 1 is a diagram showing an influence of reaction time and reaction temperature on degree of grafting.

FIG. 2 is a diagram showing an influence of irradiation dosage on degree of grafting.

FIG. 3 is a diagram showing an influence of a surfactant on degree of grafting.

FIG. 4 shows results of adsorption tests with the present metal ion adsorbent and conventional metal ion adsorbent.

### EXAMPLES

The present invention will be described in detail below, referring to Examples.

### Example 1

Emulsion graft polymerization was conducted in the following manner.

Polyethylene hollow filamentary films as a polymeric substrate were subjected to irradiation with γ-rays (160 kGy) under dry ice cooling. Immediately after the irradiation, the hollow filamentary films were dipped into a nitrogen-flushed emulsion solution prepared in advance, and subjected to reaction for 8 hours, while keeping the reaction temperature at 60° C. The emulsion solution used was a solution containing 30% di(2-methacryloyloxyethyl)acid phosphate and 2% sodium dodecylsulfate as a surfactant in pure water on the basis of total weight of the emulsion solution. Another emulsion graft polymerization was conducted under the same conditions as above, except that the reaction temperature was kept at 70° C.

For comparison, graft polymerization was also conducted in a non-emulsified system using an organic solvent, i.e., a mixed solvent comprising 70% pure water and 30% methanol. The non-emulsified system containing the same 30% di(2-methacryloyloxyethyl)acid phosphate as reactive monomers on the basis of total weight of the system as in the foregoing emulsion graft polymerization was prepared.

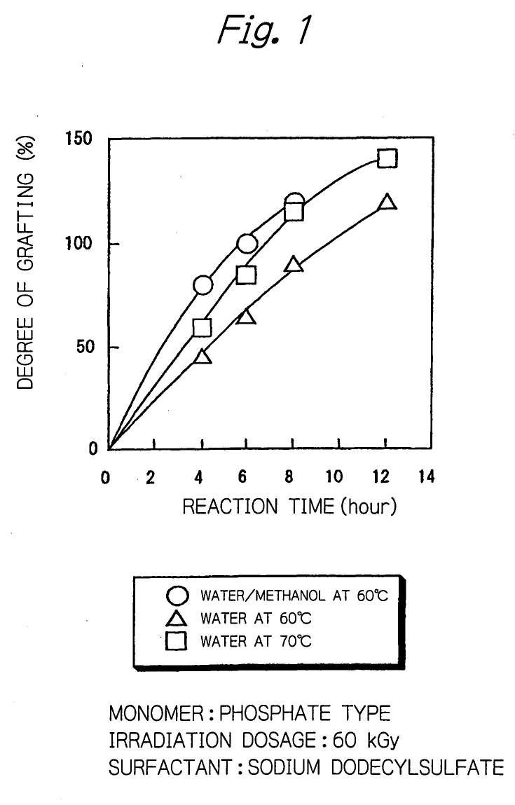

FIG. 1 shows an influence of reaction time and reaction temperature on degree of grafting.

As a result of emulsion graft polymerization in water as a solvent at 60° C., the degree of grafting in terms of a weight increment of the polymeric substrate after the reaction for 8 hours was 80%. When the reaction was continued further to 12 hours, the degree of grafting was increased to 120%. During the reaction the emulsion was kept colorless and transparent.

As a result of graft polymerization in non-emulsified mixed solvent, on the other hand, the degree of grafting in terms of a weight increment of the polymeric substrate was 120% for the reaction time of 8 hours. The non-emulsified system containing methanol had a boiling point at 65° C., and thus the reaction temperature could not be elevated to a higher temperature in this system, whereas in the present emulsion graft polymerization using water as a solvent, the reaction temperature could be elevated to a higher temperature, and at the reaction temperature of 70° C., an equivalent degree of grafting to that of the non-emulsified system could be obtained.

By continuing the reaction up to a degree of grafting of about 120%, the necessary degree of grafting of specifically working functional groups for effective working as an adsorbent could be obtained.

### Example 2

Emulsion graft polymerization was conducted in the following manner, and an influence of irradiation dosage on degree of grafting was investigated.

Polyethylene monofilaments as a polymeric substrate were subjected to irradiation with electron beams each of 50, 100 and 200 kGy in a nitrogen atmosphere. Immediately after the irradiation, the polyethylene monofilaments were dipped into a nitrogen-flushed monomer solution in an emulsion state prepared in advance, and subjected to emulsion graft polymerization, while keeping the reaction temperature at 40° C. The monomer solution used was a solution containing 10% glycidyl methacrylate and 1% Tween 80 (a product of Kanto Kagaku Co., Ltd.) as a surfactant in pure water on the basis of total weight of the solution.

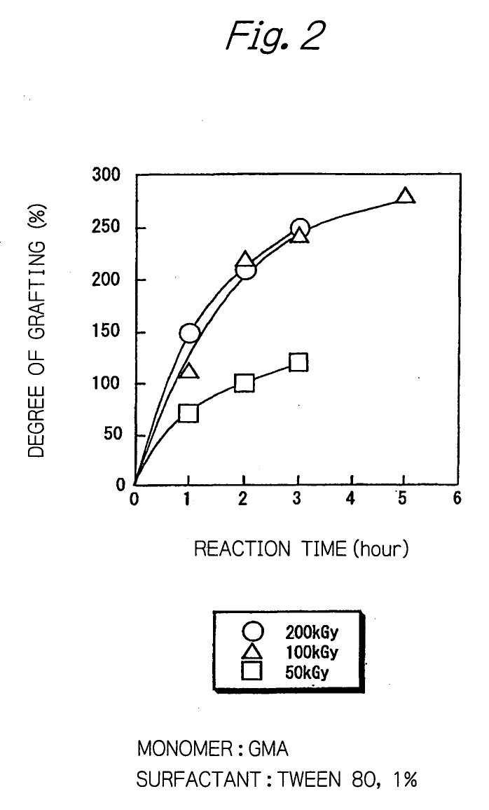

FIG. 2 shows an influence of irradiation dosage on degree of grafting.

Among the investigated irradiation dosages, there were no substantial changes in the time for obtaining desired degree of grafting at dosages of 200 kGy and 100 kGy, and one-hour reaction could attain a degree of grafting of 150%. At a dosage of 50 kGy, a degree of grafting of about 120% could be attained by prolonging the reaction time to 3 hours. During the reaction, the emulsion was kept milky white, and the dispersed phase was homogeneously dispersed through the continuous phase.

Determination of monofilament strength revealed that, when the monofilaments were subjected to irradiation of electron beam of 200 kGy, the strength was decreased from 5.8 g/d (denier) (unirradiated) to 5.0 g/d, and when the irradiation dosage was decreased to 100 kGy, the monofilament strength was 5.7 g/d, which was substantially equivalent to that of the unirradiated filaments.

When another emulsion graft polymerization was conducted under the same conditions as above, except that sodium dodecylsulfate and Amphitol (trademark of a product made by Kao Corp.) were used in place of Tween 80, the similar result could be obtained.

### Example 3

Emulsion graft polymerization was conducted in the following manner, and an influence of surfactants on degree of grafting was investigated.

Polyethylene non-woven fabrics as a polymeric substrate were subjected to irradiation with an electron beam of 200 kGy in a nitrogen atmosphere. Immediately after the irradiation, the non-woven fabrics were dipped into a nitrogen-flushed monomer solution in an emulsion state prepared in advance, and subjected to emulsion graft polymerization at 40° C. and 60° C., respectively. The monomer solution used was a solution containing 30% acrylonitrile and 5% Tween 80 in pure water on the basis of total weight of the solution.

For comparison, the same polyethylene non-woven fabrics irradiated with an electron beam of 200 kGy were dipped into dimethyl sulfoxide containing 30% acrylonitrile and subjected to graft polymerization at 40° C.

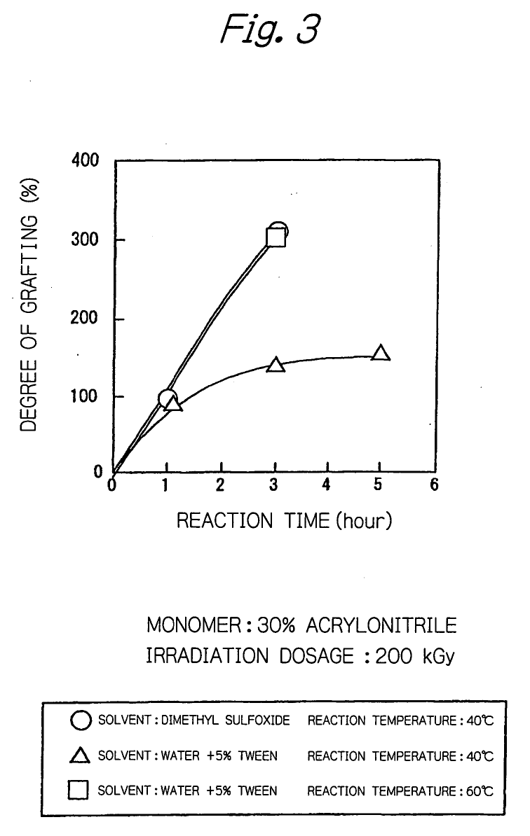

FIG. 3 shows an effect of surfactants on degree of grafting.

In both systems, the degree of grafting was increased with increasing reaction time, and comparison of both reactions revealed that the rate of reaction was lowered in the reaction in the emulsion system, but the necessary degree of grafting 120% for the adsorbent could be obtained. During the reaction, the emulsion was kept milky white.

To shorten the reaction time, the reaction temperature could be elevated to 60° C. in the emulsion system, whereby the degree of grafting could be increased substantially linearly.

### Example 4

The graft polymer obtained in the process of Example 3 was subjected to a chemical treatment to produce a metal ion adsorbent. Specifically, acrylonitrile graft polymers having degree of grafting of 100% were dipped into a 3% hydroxyamine neutral solution and subjected to reaction at 80° C. for 30 minutes to 5 hours. Density of functional groups resulting from the reaction increased with time, and 7 moles of functional groups could be introduced per kg of adsorbent for the reaction time of 2 hours. The density was 1.5 to 2 times as high as that of the adsorbent prepared in the following conventional process.

The resulting metal ion adsorbent was subjected to adsorption/desorption tests to evaluate metal ion adsorption and elution characteristics. That is, the adsorbent was dipped into a solution containing 100 ppb each of uranium ions, nickel ions, lead ions and cobalt ions, and kept at an adsorption temperature of 25° C. while stirring at pH=8 for 2 hours. After the adsorption, the adsorbent was dipped in 0.5 M hydrochloric acid and subjected to stirring at 25° C. for 2 hours, thereby eluting the adsorbed metal ions from the adsorbent.

For comparison, the conventional adsorbent was prepared in the following manner.

Olefin-based non-woven fabrics as a polymeric substrate were irradiated with an electron beam of 200 kGy. After the irradiation, the substrates were dipped into a deoxidized monomer solution in vacuum and subjected to reaction at 40° C. for 3 to 5 hours. The monomer solution used was a mixture in a 1:1 ratio by weight of a monomer solution consisting of 70 wt. % acrylonitrile and 30 wt. % methacrylic acid, and dimethyl sulfoxide as a solvent. Then, the resulting polymeric substrate with graft copolymers of acrylonitrile and methacrylic acid was dipped into a 3% hydroxylamine neutral solution and subjected to reaction at 80° C. for 30 minutes to one hour. An amount of functional groups thus introduced was 3 to 5 moles per kg of the adsorbent.

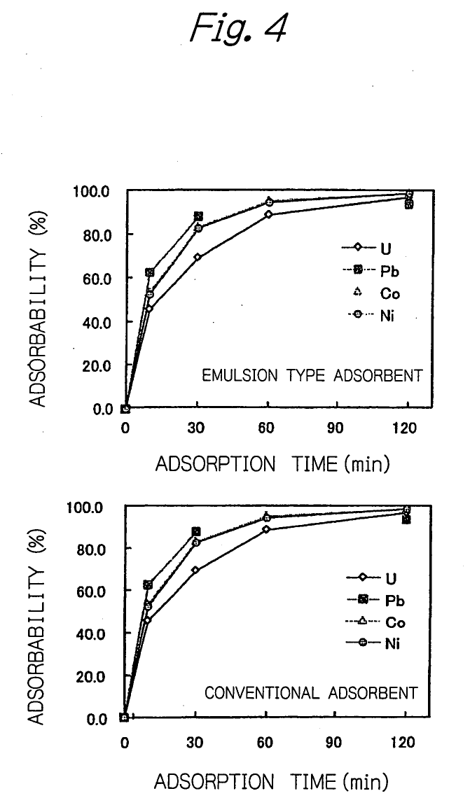

FIG. 4 shows results of adsorption tests with the present metal ion adsorbent and conventional metal ion adsorbent.

As shown in FIG. 4, the present metal ion adsorbent had equivalent percentage recovery of all the tested metal ion species to that of the conventional adsorbent.

Irradiation dose of 200 kGy, monomer concentration of 50%, and other comonomer component than acrylonitrile were indispensable for the preparation of the conventional adsorbent. In view of those facts the present invention can largely reduce the production cost and burden to the environment. Comparison of the present invention with the conventional adsorbent is given in the following Table 1.

TABLE 1
Comparison of the present invention with the
conventional adsorbent

| | | Conventional | Invention |
|---|---|---|---|
| Graft | Irradiation | 200 | 30-50 |
| polymerization | dose (kGy) | | |
| | Number of | 2 | 1 |
| | monomer | | |
| | component | | |
| | Monomer | 50% | 5-30% |
| | concentration | | |
| | Reaction | Organic | Water |
| | solvent | solvent | |
| Overall | Burden to | Large | Small |
| evaluation | environments | | |
| | Contribution | Small | Large |
| | to resource | | |
| | saving | | |
| | Production | High | Low |
| | cost | | |

1. A process for emulsion graft polymerization of a polymeric substrate, which comprises a step of activating a polymeric substrate, and a step of contacting the activated polymeric substrate with an emulsion comprising a surfactant, water, and reactive monomers, thereby graft polymerizing the reactive monomers to the polymeric substrate.

2. A process according to claim 1, wherein the surfactant is selected from the group consisting of an anionic surfactant, a cationic surfactant, an amphoric surfactant, a non-ionic surfactant and a mixture thereof.

3. A process according to claim 1, wherein the polymeric substrate is in the form of woven fabrics, non-woven fabrics, films, hollow filamentary films, flat films or threads, made from polyolefinic fibers such as polyethylene, polypropylene, etc., or natural polymeric fibers such as chitin, chitosan, cellulose, starch, etc.

4. A process for producing a metal ion adsorbent, which comprises a step of activating a polymeric substrate, and a step of contacting the activated polymeric substrate with an emulsion comprising a surfactant, water, and reactive monomers having specifically working functional groups, thereby graft polymerizing the reactive monomers having the specifically working functional groups to the polymeric substrate.

5. A process for producing a metal ion adsorbent, which comprises a step of activating a polymeric substrate, and a step of contacting the activated polymeric substrate with an emulsion comprising a surfactant, water, and reactive monomers, thereby graft polymerizing the reactive monomers to the polymeric substrate, and a step of introducing specifically working functional groups to graft chains of the reactive monomers formed by the graft polymerization.

6. A metal ion adsorbent, produced by a process according to claim 4, and reusable by washing the adsorbed metal ions off the adsorbent by an appropriate eluent.

7. A process for recovering metal ion by adsorption, which comprises a step of passing a metal ion-containing medium through a metal ion adsorbent produced according to claim 4.

8. A process according to claim 2 wherein the polymeric substrate is in the form of woven fabrics, non-woven fabrics, films, hollow filamentary films, flat films, or threads, made from polyolefinic fibers such as polyethylene, polypropylene, etc., or natural polymeric fibers such as chitin, chitosan, cellulose, starch, etc.

9. A metal ion adsorbent, produced by a process according to claim 5, and reusable by washing the adsorbed metal ions off the adsorbent by an appropriate eluent.

10. A process for recovering metal ion by adsorption, which comprises a step of passing a metal ion-containing medium through a metal ion adsorbent produced according to claim 5.
